(19) United States
(12) Patent Application Publication
(10) Pub. No.: US 2014/0192197 A1
(43) Pub. Date: Jul. 10, 2014

(54) METHOD AND APPARATUS FOR CONTROLLING ACCESS TO A HOME USING VISUAL CUES

(71) Applicant: THOMSON LICENSING, Issy de Moulineaux (FR)

(72) Inventors: James G. HANKO, Redwood City, CA (US); Christopher UNKEL, Palo Alto, CA (US); Jeffrey Duane NORTHCUTT, Menlo Park, CA (US)

(21) Appl. No.: 14/143,636

(22) Filed: Dec. 30, 2013

Related U.S. Application Data
(60) Provisional application No. 61/748,911, filed on Jan. 4, 2013.

(51) Int. Cl. G07C 9/00

(52) U.S. Cl. CPC G07C 9/00079
USPC 348/156

(57) ABSTRACT

An apparatus and method that controls access to a dwelling is provided. An image capturing device captures an image representing an individual attempting to access the dwelling. An access database includes data identifying individuals known to a user and access level data associated with each individual known to the user, the data identifying individuals known to the user including image data representative of the individual. A controller receives the captured image data from the image capturing device and determines a level of access associated with the individual attempting access by comparing the captured image data with the image data representative of individuals stored in the access database. Upon determining that the access level indicates that access should be granted, the controller controls a locking mechanism to move from a first locked position to a second unlocked position enabling access to the dwelling.

### CROSS REFERENCE TO RELATED APPLICATIONS

This application claims priority from U.S. Provisional Application No. 61/748,911 filed Jan. 4, 2013.

### BACKGROUND OF THE INVENTION

Advances in network technologies and the ability to connect any type of appliance or device to these networks has been the driving force behind the desire to create a truly automated and interconnected home. The widespread use of Ethernet and wifi networks in the home has allowed manufactures and designers to create appliance specific applications that communicate with other devices (e.g. other appliances or computing devices). These home automation networks are still in their infancy due, in large part, to the number of different device and appliance manufactures making these products. This necessarily increases the likelihood of miscommunication between devices and/or appliances resulting in a non-desirable experience for the user.

Additionally, a main focus of home automation and interconnectivity has been appliances and devices used on a daily basis such as a refrigerator, stove, etc. Each of these devices, while connected to a network and providing information to a user via network communications, only focus on information relevant to that particular device or appliance. A drawback with this manner of home automation is the user may be presented with a plurality of different messages in different formats from each interconnected device which requires significant additional manual work on their behalf to make sense of and implement the recommendations and suggestions provided by the device/appliance.

Furthermore, there has been little discussion of certain, more basic, interactions a user has with their home. For example, conventional home automation systems fail to provide a convenient and comprehensive system for controlling access to a particular home and conditioning other devices in the home based on this access. One of the key requirements of personalized home automation is the recognition of residents. Without successfully recognizing residents present in the home, the home automation system may incorrectly adapt the different devices in the home to those present therein. A drawback of convention home automation systems relate to this inability to provide resident recognition for all connected devices. Thus, it is desirable to overcome these and other problems associated with current home automation systems.

### SUMMARY OF THE INVENTION

In a first embodiment, an apparatus that controls access to a dwelling is provided. An image capturing device captures an image representing an individual attempting to access the dwelling. An access database includes data identifying individuals known to a user and access level data associated with each individual known to the user, the data identifying individuals known to the user including image data representative of the individual. A controller receives the captured image data from the image capturing device and determines a level of access associated with the individual attempting access by comparing the captured image data with the image data representative of individuals stored in the access database. Upon determining that the access level indicates that access should be granted, the controller controls a locking mechanism to move from a first locked position to a second unlocked position enabling access to the dwelling.

In a further embodiment, a method of controlling access to a dwelling is provided. The method includes capturing, via an image capturing device, an image representing an individual attempting to access the dwelling and receiving, at a controller, the captured image data from the image capturing device. A level of access associated with the individual attempting access is determined by comparing the captured image data with the image data representative of individuals stored in an access database. The access database includes data identifying individuals known to a user and access level data associated with each individual known to the user, the data identifying individuals known to the user including image data representative of the individual. In response to determining that the access level indicates that access should be granted, the controller controls a locking mechanism to move from a first locked position to a second unlocked position enabling access to the dwelling.

### BRIEF DESCRIPTION OF THE DRAWINGS

These and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows a block diagram of an exemplary embodiment of the system according to invention principles;

FIG. 2 shows an exemplary block diagram of an access control device for use with the system according to invention principles;

FIGS. 3A-3C are an exemplary user interfaces for use in operating the access control device according to invention principles;

FIG. 4 is an exemplary user interface associated with an exemplary feature according to invention principles;

FIG. 5 shows an illustrative view of the access control device according to invention principles; and

FIG. 6 is a flow diagram detailing an algorithm for operating the access control device according to invention principles.

### DETAILED DESCRIPTION OF THE PREFERRED EMBODIMENT

The exemplifications set out herein illustrate preferred embodiments of the invention, and such exemplifications are not to be construed as limiting the scope of the invention in any manner.

The system according to invention principles advantageously provides a method and apparatus enabling access level configuration for any person who attempts to gain access to the dwelling and who is not recognized by the apparatus. The user can associate or otherwise describe the image of the unrecognized person and assign an access level to that person. The access level may include at least any one of (a) deny access; (b) permission-based access; and (c) full access. The system automatically adds the newly assigned user to a database and, at a later date when that user attempts access again, the system will advantageously provide access in accordance with the assigned access level. The system may also advantageously generate a list of visitors to the dwelling when no one was home. The apparatus determines the identity of the visitor and automatically communicates a list of visitors to the owner of the dwelling. This list of visitors may also include a mechanism for contacting the visitor. Additionally, in the instance that the visitor is not recognized, the list of visitors may also enable the user to initiate the access level configuration for that visitor as discussed above. In a further embodiment, the system advantageously attempts to recognize a person entering a dwelling and automatically configures a plurality of different devices, appliances and applications according to preferences associated with the recognized user.

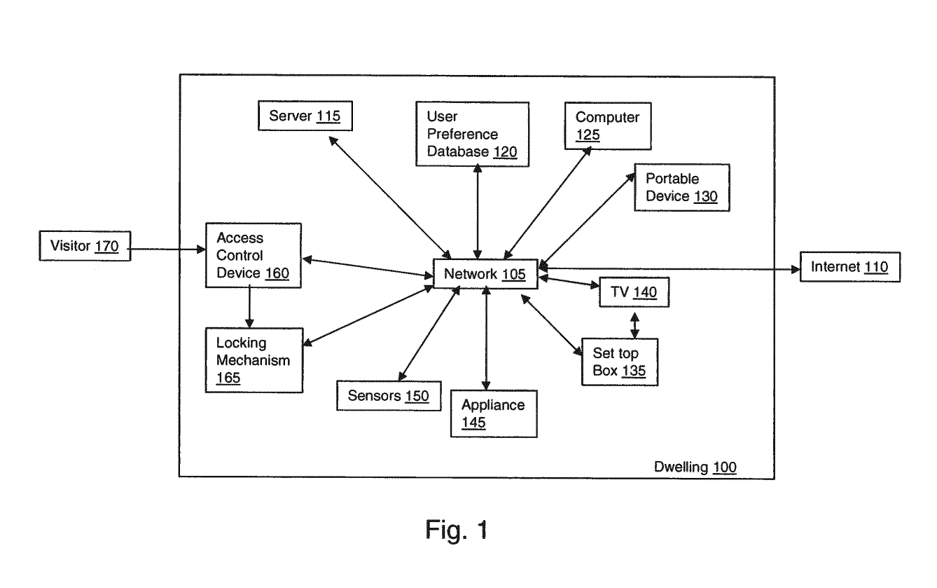

Referring to FIG. 1, a block diagram of an exemplary embodiment of a connected dwelling 100 is shown. As used herein, the term dwelling is meant to be any structure inhabited by a person or persons. The dwelling may be a personal residence (e.g. home, apartment, mobile home, etc) or a business. The dwelling 100 includes a plurality of different devices that are interconnected with one another via a network 105. As used herein, the term device is used generically and refers to anything that may be connected to and communicate using the network 105. For example, a device includes, but is not limited to, one of an electronic device and an appliance. Exemplary devices that are connected via network 105 will be described in more detail below. The network 105 may be facilitated by a router, gateway or other networking device and enables communication between devices. The network 105 may be a wired network, wireless network, and a cellular network. In practice, it is likely that network 105 will be formed from a combination of these networking structures that operate in accordance with the communication protocols typically associated therewith. Additionally, the network 105 enables the dwelling, and any device connected therein, to access a wide area network such as the Internet 110.

In a connected dwelling 100 it is desirable to have a plurality of devices connected to one another via network 105 such that bidirectional communication between any and all devices may occur. Depicted in FIG. 1 is a sample of various types of devices that may be connected via network 105 and controlled by the system according to invention principles. Devices may include, but are not limited to, (a) a server 115; (b) a user preference database 120; (c) a computer 125; (d) a portable electronic device 130; (e) a settop box 135; (f) a TV 140; (g) an appliance 145; and (h) at least one sensor 150. Additionally, it should be understood that each device described above represents a type of device. In practice, as will be illustrated below, there may be a plurality of each type of device in each dwelling 100.

The computer 125 may include at least one of a desktop computer and a laptop computer. The portable electronic device 130 may be any portable electronic device including a mobile phone, tablet computer, music players, cameras, global positioning navigation systems etc. The portable electronic device may include the ability to send and receive phone calls and text messages, interface with the Internet either through a cellular network or a local wireless network, take pictures and videos, play back audio and video content, and run applications such as word processing, programs, or video games. These portable electronic devices 130 also include a touch screen panel as part of the user interface.

In the case where the portable electronic device 130 communicates via a cellular network, the information transmitted may be encoded in various formats, such as time division multiple access (TDMA), code division multiple access (CDMA) or Orthogonal frequency-division multiplexing (OFDM). Information is transmitted and received using multiple antennas encoders, demodulators and the like used to encode and decode information into the appropriate formats for transmission. In this embodiment, the portable electronic device 130 may be used to facilitate voice or text transmissions, or transmit and receive information from the internet, including, but not limited to, video, audio, and/or image data.

In the case where the portable electronic device 130 communicates via a wireless network (e.g. using a wifi network interface), the device 130 may selectively transmit and receive information over a wifi network. This information can be encoded in various formats according to different wifi standards, such as 802.11g, 802.11b, 802.11ac and the like. Information may be transmitted and received using multiple antennas, encoders, demodulators and the like used to encode and decode information into the appropriate formats for transmission and decode information for demodulation. Moreover, portable electronic device 130 may be used to facilitate voice or text transmissions, or transmit information to and receive information from the internet. This information may include video, audio, and/or image data.

At least one set top box 135 coupled to at least one television 140 may also be connected via network 105. The at least one set top box 135 selectively receives at least one of analog and digital signals including audio video data and uses a plurality of decoders and demodulators to process the received signals for display on the at least one television 140. The set top box 135 selectively receives and processes multimedia content from a content provider. Multimedia content may include, but is not limited to, audio content, video content and audio video content. Multimedia content may include, but is not limited to, broadcast television content; on-demand content; pre-recorded content; streaming content and the like. The set top box may also be internet capable (e.g. wired and/or wireless) and can selectively receive networking data. The networking data may be associated with the received audio video data stream. Alternatively, the networking data may be local area network specific such as data associated with the home automation system according to invention principles. For example, the set top box 135 may receive message data from any other device connected on the network 105 and selectively cause the received message data to be output for display on the at least one television 140. Examples of this operation will be discussed in further detail below. The at least one set top box 135 may also include digital video recording (DVR) capabilities for selectively scheduling recordings of content and enabling playback thereof. The DVR functionality may be hosted locally on set top box 135. Alternatively, the DVR capabilities may be cloud based whereby the set top box 135 accesses the internet 110 via network 105 to acquire content that was scheduled for recording but is hosted at a location other than the set top box 135. This location may be on another device connected to network 105 (e.g. personal computer) or a cloud-based storage provider outside the dwelling 100. The description of the set top box 135 merely illustrates common functionality and operation of a convention set top box provided from a cable and/or satellite provider. Thus, persons skilled in the art will understand that this description should not be considered as limiting the available functionality of set top box 135.

Additionally, while the at least one television 140 is shown as being connected to the at least one set top box 135, it should be noted that the at least one television may be directly connected to other devices on network 105 without needing to be connected to the set top box 135. Thus, the at least one television 140 includes a networking interface enabling a connection with any other device on network 105 via a wired interface (e.g. packet switched network) or wireless interface (e.g. wifi). This advantageously enables the at least one television 140 to selectively receive and display information from and about other devices on the network 105.

At least one appliance 145 may also be connected to the network 105. Each of the at least one appliance also includes a network interface such as the one described above with respect to the at least one television 140. Thus, the at least one appliance may selectively receive information from other devices and provide information to other devices via network 105. Moreover, because the at least one appliance is connected to the network 105, any function able to be performed by the at least one appliance 145 may be selectively controlled by another device, either in response to a user command or automatically in response to a set of previously stored control preferences associated with the respective appliance 145. As used herein, the term appliance means any device able to perform a particular function in a particular manner. For example, the at least one appliance 145 may include, but is not limited to, any of (a) a refrigerator; (b) an oven; (c) a dishwasher; (d) a microwave oven; (e) a coffee maker; (f) a washing machine; (g) a dryer; (h) a heating device (e.g. boiler); (i) a cooling device (e.g. air conditioner—either individual unit or a central air conditioning system); (j) a dehumidifying device; and (k) a gas-powered fireplace. The examples of appliances listed above is for purposes of example only and any should not be considered exhaustive as there are any number of large and small appliances that may be used to perform a certain function. Therefore, any appliance can include any device for performing any function that includes a networking interface enabling interconnection with other devices via network 105.

At least one sensor 150 is also connected via the network 105. The at least one sensor 150 is able to selectively sense information associated with a particular object within the dwelling. The term object as used herein should be understood to mean any system, appliance and/or device within the dwelling 100. The sensors 150 also include networking interfaces enabling interconnection with other devices on network 105. The sensors are able to sense information about the object to which they are connected and provide the sensed information to other devices on the network. Additionally, the sensors may also receive control messages from other devices on the network. The control messages may be received in response to at least one of (a) sensed information; (b) a user command; and (c) prestored preferences associated with the object. In response to the sensors 150 receiving the control message, the sensor 150 may selectively control the object to which they are connected to operate in a particular manner. In one embodiment, sensors 150 may be lighting sensors that sense an operational state (e.g. on, off, dimmed to a desired level) of all lights or a sub-set of lights within a dwelling. In another embodiment, sensors 150 may be temperature sensors (e.g. thermostats) connected to at least one of a heating system and cooling system to control an operational state thereof and cause the ambient temperature in the dwelling or in a particular room of the dwelling to reach a predetermined temperature level. In a further embodiment, sensors 150 may include gas sensors such as a carbon monoxide detector for sensing a presence of carbon monoxide in the dwelling. Sensors 150 may also include power sensors connected to the electrical wiring system of the dwelling that sense a power level within the dwelling 100. Sensors 150 may also include water sensors able to sense the presence of water at a location in the dwelling. Sensors 150 may also be connected to any point of ingress/egress from the dwelling (e.g. windows, doors, vents, etc) for sensing whether the point of ingress/egress is one of open or closed. The above types of sensors are described for purposes of example only and any sensor for sensing any information about and controlling the operation of any object in the dwelling 100 may be implemented with the present system.

At least one server 115 and an associated user preference database 120 may also be interconnected with any device via network 105. The user preference database 120 includes at least one record identifying a particular user of the system and at least one preference of that user associated with at least one device connected on the network 105. The at least one preference identifies a manner in which the device should operate in a given circumstance (e.g. time of day). The user preference database 120 may identify users as “users” or “visitors”. A “user” means that the person lives in or otherwise occupies the dwelling 100 for a majority of the time whereas a “visitor” is any other person not identified as a “user”. Preference data may also be stored and associated with “visitors” as well as “users”. When a device uses preference data to determine how it should operate in a given circumstance, the device may query the user preference database 120 to identify any “users” and/or “visitors” present at a given time and use preference data associated with any of the “users” or “visitors” determined to be present. In one embodiment, a device may use preference data associated with the “user” to determine how it should operate. In another embodiment, the device may consider both “user” and “visitor” preference data when determining how to operate. In this embodiment, the device may prioritize preferences associated with a “user” over preferences associated with any “visitors”, or vice versa. The device may also prioritize certain “users” over other “users”.

The at least one server 115 may be specifically programmed to execute at least one application controlling at least one other device connected via network 105. For example, the server 115 may execute a butler application that selectively controls the operation of a plurality of devices in a given circumstance or in response to the occurrence of a particular event. The server 115 may direct any of the devices to operate in a certain manner and further instruct the device to query the user preference database 120 to determine if there are any pre-stored preferences that will control the operation of that device in the given circumstance. Additionally, the server 115 may continually receive messages from each device connected via network 105 and update the user preference database with information about how the device should operate in a given circumstance. This manner of continually updating user preference database 120 provides a learning feature which advantageously improves the home automation features implemented by the butler application.

At least one access control device 160 is provided coupled to a respective locking mechanism 165 and selectively controls the operational state of the locking mechanism 165. The at least one access control device 160 and its respective locking mechanism 165 may be located at any point of ingress/egress from the dwelling including, but not limited to front and back doors and garage doors. The at least one access control device 160 selectively controls access to the dwelling by causing the locking mechanism 165 to move from a first locked position to a second open position when it is determined that a visitor 170 should be granted access. The access control device 160 is further connected to any other device in the dwelling 100 via network 105. The at least one access control device 160 may also selectively configure at least one other device connected on network 105 to operate in a certain manner. The configuration of devices on the network by the access control device 160 may be performed in response to specific user commands received thereby or in response to at least one pre-stored user preference.

Every device that is interconnected via network 105 communicates with one another using a common communication protocol. The common communication protocol employed by the system according to invention principles includes devices generating and broadcasting messages to and receiving messages from any device connected via network 105. The messages include (a) a device identifier identifying the source of the message; and (b) information usable by at least one other device that controls the at least one other device to operate in a certain manner. This information may include a direct command from the transmitting device causing the receiving device to operate in a particular manner. Alternatively, this information may instruct the receiving device to look to a source of configuration information that will determine the manner in which the device should operate. In another embodiment, the messages may also include information about at least one other related device that may work in connection with the receiving device instructing the receiving device to communicate or otherwise interact with the at least one other related device in order to operate in a particular manner.

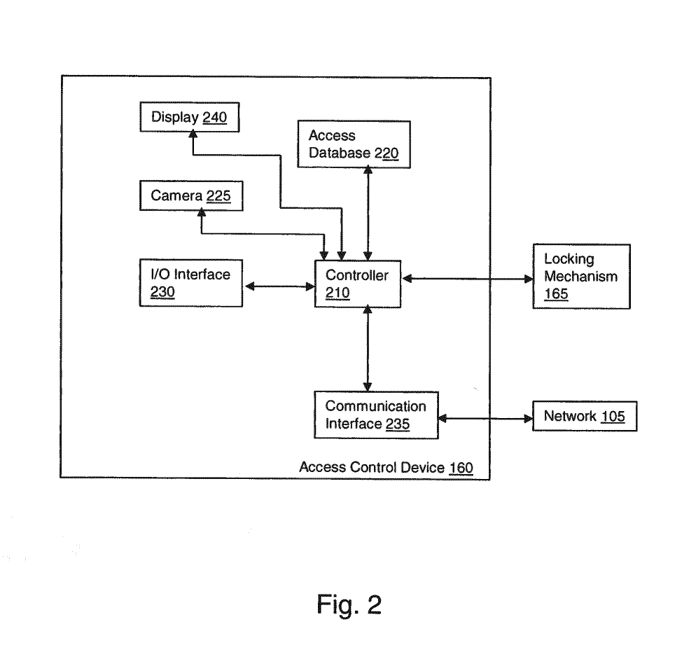

FIG. 2 is a block diagram of an exemplary user access control device 160 as shown in FIG. 1. In the context of the present invention, the user access control device 160 advantageously seeks to recognize a person who approaches the dwelling 100 and seeks entry thereto. The user access control device 160 senses at least one visual characteristic associated with a person to automatically identify the person and determine a level of access to the dwelling 100 that is associated with that person. The user access control device 160 further advantageously enables a user to create a user access level with any person that is not recognized by the user access control device 160.

The user access control device 160 includes a controller 210 that executes at least one application controlling the operation thereof. The controller 210 is coupled to the locking mechanism 165 and selectively controls the locking mechanism to move between a first locked position and second unlocked position depending on the access level associated with the person attempting to gain access to the dwelling.

An access database 215 is coupled to the controller 160 and includes records including information identifying any person that has attempted to gain access to the dwelling and access level data identifying a level of access associated with that person. Information identifying the person who attempted to access the dwelling 100 may include at least one of (a) image data associated with a face of the person; (b) characteristic data describing at least one characteristic of the person; and (c) audio data representing a sample of the person's voice. Access level data includes one of (a) full access; (b) permission-based access; (c) event based access; and (d) no access. The access database 220 may also include records of individuals known to a “user” of the system that do not include access level information. The records of individuals known to the “user” may be derived from at least one of (a) a user contact list; (b) a friends list associated with a social networking application (e.g. FACEBOOK, GOOGLE+, etc); and (c) contact information from a communication application (e.g. SKYPE; HOTMAIL; GMAIL, etc). A list of known individuals may be derived from one of (a) applications executing on the server 115; (b) application executing on the computer 125; and (c) applications executing on the portable device (e.g. mobile phone, tablet, etc). The list of known individuals may also be acquired from the user preference database 120 in FIG. 1. In another embodiment, the list of known individuals may be acquired via the internet 110. Information associated with known individuals may or may not include image data or characteristic data associated with that individual and instead may only include a text-based identifier. Including a list of known individuals in the access database advantageously provides the user with a selection of candidate individuals when assigning an access level to a person that is not recognized by the user access control device 160.

The user access control device 160 also includes a camera 225 for capturing data representing a face of a person seeking access to the dwelling 100 as well as an input/output interface 230 that includes buttons, a speaker/microphone for use in communicating audible messages from the person seeking access to a user within the dwelling.

A communication interface 235 is coupled to the controller 210 and selectively enables communication with any device via network 105. Specifically, the communication interface 235 is able to transmit access event messages generated by the controller 210 identifying persons attempting to access the dwelling. The access event message includes information identifying the person seeking access to the dwelling, information identifying a determined access level associated with the person seeking access to the dwelling and formatting information including formatting instructions used to provide a user with a notification of the particular access event. The communication interface 235 is also able to selectively receive messages from other devices on the network 105 that direct the access control device 160 to operate in a particular manner. The access control device 160 may also include a display screen 240 coupled to the controller 210 that selectively provides information about an access request to the person attempting to access the dwelling 100.

In exemplary operation, a person seeking access to the dwelling 100 approaches the user access control device 160 which is positioned on an exterior surface of the dwelling. The camera 225 captures image data representing the person's face in a known manner. The controller 210 receives the image data representing the person's face and executes a facial recognition algorithm to determine if the person seeking access to the dwelling has an access level associated therewith. The controller 210 uses the image data and queries the access database 220 to determine if the captured image data matches any image data stored in the access database 215 that is associated with a person that has previously attempted to access the dwelling 100. If the controller 210 determines that the captured image data matches the image data associated with a person that has previously sought access to the dwelling 100, the controller 210 uses the designated access level data to control the operation of the locking mechanism 165.

If the access level is determined to be “full access” the controller 210 automatically controls the locking mechanism 165 to move from the first locked position to the second unlocked position. The controller 210 may generate an access event message including information identifying the person and indicating that full access to the dwelling was granted. The access event message may be communicated to other devices on the network 105 via the communication interface 235. The access event message announces to every other device that an access event has occurred and any device on the network 105 configured to receive and/or use information about access events may use the information in the desired manner. Any device configured to receive the access event message indicating that full access was granted may provide to a user within the dwelling a notification identifying the person granted full access.

If the access level is determined to be “permission-based access”, the controller 210 generates an access event message including a request to allow the person access to the dwelling. The communication interface 235 communicates the access event message via network 105 for receipt by any device on the network 105 that is configured to receive access event messages and provides, on a respective device, information indicating that the person seeking access to the dwelling is known and requires permission from the user to access the dwelling. The device providing the user with the access event message may generate and communicate an access response message including information granting access or denying access to the user at the given time. The access response message may be received by the communication interface 235 and parsed by the controller 210 to determine if access should be granted. If the controller determines that access should be granted, the controller 210 will cause the locking mechanism 165 to move from the first locked position to the second unlocked position. If the controller 210 determines that access should not be granted, no action will be taken. In one embodiment, the controller 210 may cause a message to be output for display on display screen 240 indicating that the request for access is denied. This message may or may not include context information indicating why the request for access was denied. In another embodiment, the controller 210 may cause the I/O interface to output an audible message indicating that the access request was denied.

If the access level is determined to be “event-based access”, the controller 210 queries whether an identified event that triggers access to the dwelling has occurred. Events may be at least one of (a) date specific; (b) time specific; and (c) day of the week. An event that triggers access may be at least one of (a) a one-time event; (b) a repeating event; and (c) a scheduled event. These types of events are described for purposes of example only and any type of event can be associated with a particular person that seeks access to the dwelling. If the event criterion is determined to be satisfied, the controller 210 may control the locking mechanism 165 to move from the first locked position to the second unlocked position. The result of an event based access determination may also be included in an access event message generated by the controller 210 for communication via communication interface 235 to any other device on the network 105 thereby providing a user with a notification regarding the person seeking access to the dwelling. For example, an event may be associated with a home healthcare worker who is scheduled to come to the dwelling on a given day of the week at a particular time. Upon capturing the facial image data of the worker and determining that it is in fact the worker seeking access, the controller 210 may determine if the current date and time matches the scheduled event date and time stored in the access database 215 to determine if access to the dwelling should be granted.

If the access level is determined to be “no access”, the controller 210 generates an access event message indicating that a person who is not permitted access to the dwelling has attempted to access the dwelling. The controller 210 automatically generates a message for output on display 240 indicating that access is denied.

In one embodiment, the set top box 135 in FIG. 1 may be configured to receive and of the above described access event messages and, in response to receiving the access event message and determining that a television 140 connected thereto is “on”, may cause the access event message to be displayed on the television 140 thereby notifying the user watching the television that a known individual was granted access to the dwelling. In another embodiment, the portable electronic device 130 may be configured to receive any of the access event messages and cause any received access event messages to be displayed to a user. Thus, a user may be provided with a notification of an access event on their cell phone and/or tablet. In this embodiment, the user does not necessarily need to be within the dwelling to receive the access event message because these messages may be communicated to the portable electronic device 130 via the internet or cellular communication network (depending on the device). This advantageously notifies the user of any attempted access to the dwelling whether or not the user is in the dwelling.

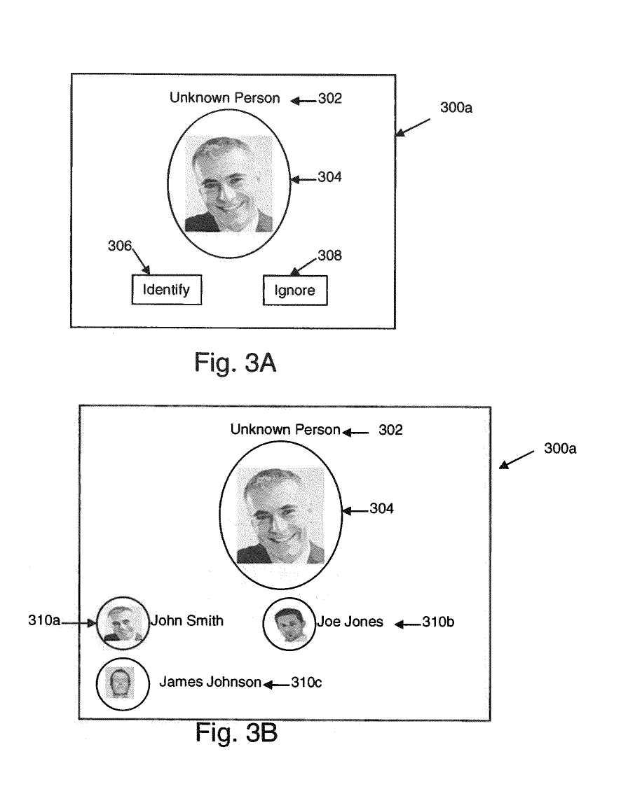

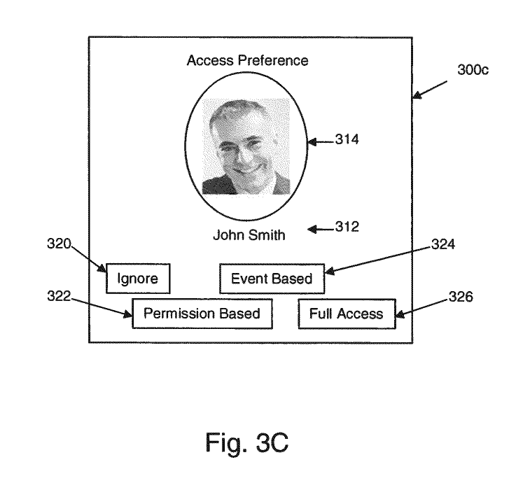

In the event that the camera captures image data associated with a person seeking access to the dwelling and the controller 210 determines that no corresponding image data identifying the person and/or an access level associated with the person is stored in the access database 215, the controller 210 identifies the person as an “unknown person” and initiates an access level assignment algorithm. The access level assignment algorithm advantageously enables a user to determine if the unknown person should have an access level associated therewith. In this manner, the controller 210 receives image data associated with a person from the camera 225 and selectively generates an access event message enabling the user to assign an access level to the person for storage in the access database 215. The process for assigning an access level to a user will be discussed below with specific reference to FIGS. 3A-3C.

In response to determining that an unknown person is present and seeks entry to the dwelling 110, the controller generates the access event message prompting a user to identify the unknown person and associate an access level with the unknown person. The access event message includes formatting information used in generating a user interface for display on a device connected to the network 105 that is able to generate a visual output including the user interface representative of the access event message and is also able to receive an input from a user in response to information included in the access event message. In one embodiment, the device may be the portable electronic device (e.g. mobile phone and/or tablet). FIG. 3A is an exemplary user interface 300 representing an access event message that indicates an unknown person is attempting access to the dwelling. The user interface 300 includes an unknown person identifier 302 that announces to the user that an unknown person is seeking access to the dwelling. The user interface 300 also includes a visual representation 304 of the unknown person. The visual representation may include the image data captured by the camera 225 which is included as part of the access event message for inclusion in the user interface 300. The user interface 300 also includes an identify action button 306 and an ignore action button 308. The buttons 306 and 308 may be user selectable image elements that, upon selection thereof, cause an access event response message to be generated and communicated to the access control device 160. Selection of the identify button 306 generates a response message continuing the access level assignment algorithm whereas selection of the ignore button 308 ends the access level assignment algorithm.

In response to selection of the identify button 306 in FIG. 3A, a response message is generated by the device and received at the communication interface 235 of the access control device 160. The controller 210 uses the captured image data representing the unknown person and compares the captured image data with image data associated with any known users that are stored in the access database 220 to generate a set of candidates. Persons known to the user that are selected as candidates have visual characteristics similar to the visual characteristics of the unknown person based on the captured image data. A list of candidates including identification information and image information is included in a further access event message which is communicated back to the device by the communication interface 235. The further access event message including the list of candidates having similar visual characteristics is shown in user interface 300b in FIG. 3B. User interface 300b is updated to include image elements 310a-310c representing each of the candidates having similar visual characteristics. Each image element representing a respective candidate includes a visual identifier that depicts an image of the candidate and a text based identifier identifying the person by name. By providing a set of candidates, the user is provided with a visual comparison of the captured image of the unknown person and images of each candidate that is determined to be visually similar to the unknown person based on facial recognition and comparison employed by the controller 210. Upon determining that the unknown person is one of the candidates listed in user interface 300b, the user may interact with the device to select the corresponding image element from within the user interface. In the example shown here, the user has determined that the visual representation 304 is “John Smith” and selects image element 310a. In response to selecting image element 310a, identification information associated with John Smith that is stored in the access database is acquired and the captured image data is associated with the identification information in the access database 220. Thereafter, the user interface 300c in FIG. 3C is generated and used to assign an access level with the previously unknown and newly identified person seeking access to the dwelling. The user interface 300c in FIG. 3C includes the identification information associated with the selected candidate John Smith stored in the access database 220. This identification information includes the name of the person 312 and a visual representation of the person 314. The visual representation may be the captured image data or image data associated with a user profile for the candidate that was stored in the access database 220. User interface 300c also includes access type image elements. The access type image elements include an ignore image element 320, a permission-based image element 322, an event based image element 324 and a full access image element 326. A user may select one of the access type image elements to assign an access level to the person seeking access to the dwelling. In response to selection of a respective access level, the device generates an access event response message confirming the identification of the person seeking access to the dwelling and an access level associated with that person. The access event response message is received by the communication interface 235 of the access control unit 160 and is provided to the controller 210 which causes the appropriate record in the access database 220 to be updated accordingly.

In the instance that a user selects the event based image element, a further user interface is generated and includes at least one user fillable field and/or user selectable image elements enabling the user to enter event criteria that must be satisfied to grant entry to the person at a later date. In this embodiment, the user entered event criteria data is included in the access event response message for use in updating the access database 220.

The above described embodiment of the access control device 160 includes the controller 210 and access database 220 used to determine if a person attempting to access the dwelling is known is described to illustrate the operational principles of the access control unit 160. The access database 220 may not be included within the access control device 160 itself and instead may be embodied as part of the user preference database 120 and/or server 115. Additionally, the facial recognition algorithm for determining if a person seeking access to the dwelling is known need not be directly executed by the controller 210. Instead, in an alternate embodiment, the controller 210 may select a portion of the image data captured by the camera 225 and determined to be the face of the person for communication to the server 115 which can perform the facial comparison and recognition aspects of the present invention.

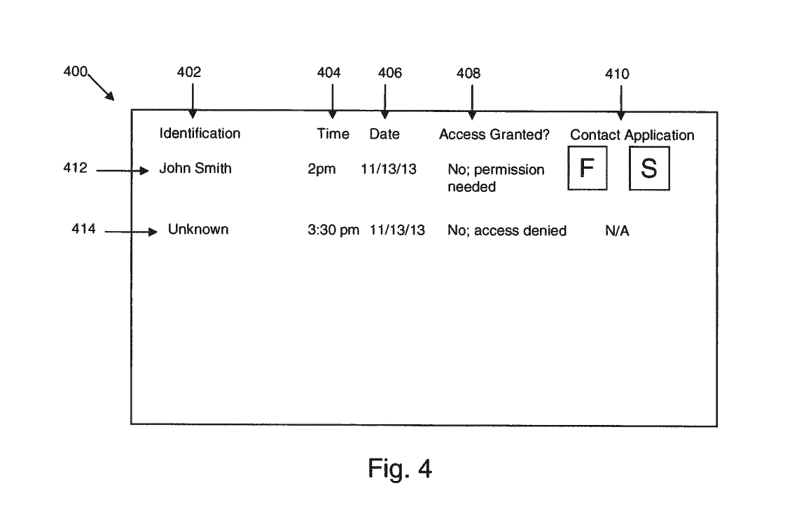

Referring back to FIG. 2, the access control unit 160 may also advantageously generate a list of access attempts that have occurred during a predetermined time period. This provides the user with a notification as to the person or persons who have attempted to access the dwelling 100 during the predetermined time period. The list of access events may include data identifying the person attempting to access the dwelling 100, a time stamp identifying a time of attempted access, a date stamp identifying a date of attempted access, data identifying whether or not access was permitted based on access level information associated with the person and data identifying a manner in which the user may contact the person who tried to access the dwelling at a later date. The data identifying a person attempting access and whether access was permitted may be derived from the access database 220 via facial recognition as discussed above. The data identifying a manner in which the user may contact the person may also be derived from the access database 220 which includes various communication applications able to be used to contact the person. For example, this information could be an email address and/or a Skype user ID and/or a Facebook profile. In this embodiment, the controller 210 records each attempt to access the dwelling and stores this information in a memory that may be embodied on the controller 210. At a predetermined time or in response to a predetermined event, the controller 210 may generate an access event message including the above information for display on a device connected to the network 105. An example of this type of access event message is shown in FIG. 4 which represents a user interface 400 that includes the list of access attempts during the predetermined time period. As shown in FIG. 4, the exemplary user interface 400 includes a tabular display including an identification column 402 that identifies the person attempting to access the dwelling, a time column 404, a data column 406, an access column 408 identifying whether access was granted, and a contact application column 410 including at least one user selectable image element enabling initiation of at least one communication application for contacting the person who attempted access. The rows of user interface 400 include individual access attempt events. As shown herein, user interface 400 notifies a user of two attempted access events 412 and 414. Event 412 notifies a user that a known person, John Smith, attempted to access the dwelling 100 at “2 pm on Nov. 11, 2013” and that access was not granted because the access level associated with John Smith is permission-based and no permission was granted. Event 412 also includes an “F” image element enabling communication with John Smith via Facebook as well as an “S” image element enabling the user to communicate with John Smith via Skype. These image elements are merely illustrative and any image element associated with any type of communication application which may be used. Event 414 indicates that an unknown person attempted to access the dwelling 100 at 3:30 pm on Nov. 11, 2013 and that access was not granted because the person was not recognized by the access control device. In this case, no communication image elements appear in column 410. In an alternate embodiment, a person attempting to access the dwelling who is not recognized by the access control device 160 may leave a message using I/O interface 230 that may include information identifying the person as well as information for use in contacting the person.

In one embodiment, the listing of access attempts for a particular dwelling may be communicated to a user at a predetermined time period. For example, a user can schedule the delivery of the list of access attempts for a time when they arrive home from work in the evening. In another embodiment, the controller 210 may automatically generate and communicate the list of access attempts in response to detecting that a user has returned home. For example, when a user returns to the dwelling 100 and their mobile phone connects to the local wifi network, the communication interface 235 can receive a message indicating that the user is home resulting in the communication of the listing of access attempts at that time. The timing and manner in which the list of access attempts is delivered to the user is described for purposes of example only and any manner of delivery and timing for delivery may be selected by the user.

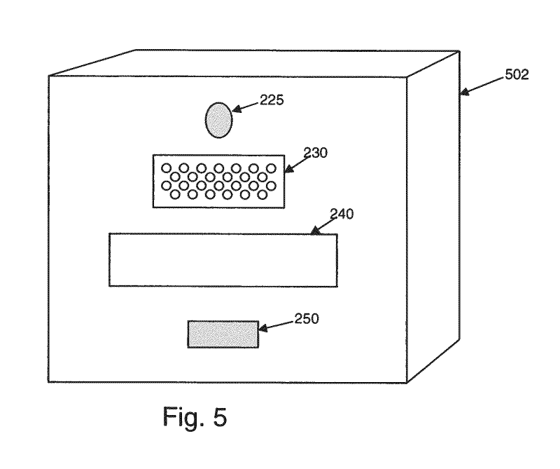

FIG. 5 is an illustrative view of an exemplary access control device 160. The access control device includes a housing 502 including all components described above with respect to FIG. 2. The housing may be selectively mountable on a dwelling 100. Alternatively, the housing 502 may be free standing and positioned within a predetermined proximity of the dwelling (e.g. at a front gate or driveway gate). The housing 502 includes the camera 225 and I/O interface 230 that includes the speaker and the microphone. The housing 502 also includes the display screen 240 for selectively displaying a message to the person attempting to access the dwelling. A notification button 250 is also positioned on the housing 502. Activation of the notification button sends a notification to the controller 210 that access to the dwelling is requested. In one embodiment, activation of the notification button 205 causes the controller 210 to initiate image capture using the camera 225. In another embodiment, the camera 225 may include a motion detector and automatically initiate image capture in response to detecting motion associated with a user attempting to access the dwelling 100. The shape, size and dimension of the housing 502 shown in FIG. 5 is provided for purposes of example only and may instead be any shape and/or size such that it is able to include all of the components described above.

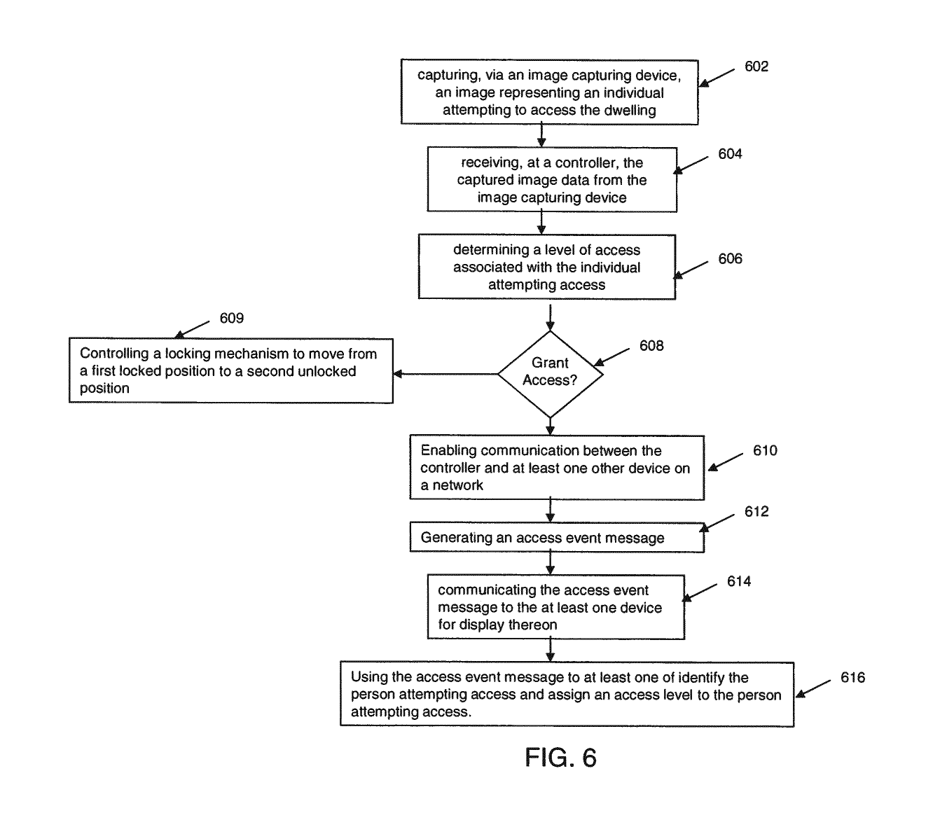

FIG. 6 is a flow diagram detailing an exemplary method for controlling access to a dwelling. In step 602, an image representing an individual attempting to access the dwelling is captured using an image capturing device. The captured image is received from the image capturing device in step 604. A level of access associated with the individual attempting access is determined in step 606. The determining step 606 may occur by comparing the captured image data with the image data representative of individuals stored in an access database. The access database includes data identifying individuals known to a user and access level data associated with each individual known to the user and the data identifying individuals known to the user including image data representative of the individual. In one embodiment, the access level data includes one of (a) full access; (b) permission-based access requiring permission of a user to grant access; (c) event based access requiring at least one event criteria to be satisfied to grant access; and (d) no access.

In step 608 a query regarding whether or not access should be granted. If the result of the query in step 608 is positive indicating that the determined access level indicates that access should be granted, a locking mechanism is controlled to move from a first locked position to a second unlocked position enabling access to the dwelling in step 609. If the result of the query in step 608 is negative, then communication between the controller and at least one other device on a network via a communication interface is enabled in step 610 to ascertain whether or not the individual attempting to access should be allowed to access and/or whether or not an access level should be associated with the individual attempting access.

In step 612, an access event message is generated. The access event message includes information identifying the person seeking access to the dwelling, information identifying a determined access level associated with the person seeking access to the dwelling and formatting information including formatting instructions used for displaying the access event message on the at least one device. The communication interface communicates the access event message to the at least one device for display thereon in step 614. In step 616, the access event message may be used in order to at least one of identify the person attempting access and assign an access level to the person attempting access.

In one embodiment, the individual attempting to access the dwelling is identified as an unknown person in response to determining that that image data associated with known individuals and stored in the access database does not match the captured image data and step 614 may also include generating an access event message and communicating the access event message to the at least one device for display thereon. In this embodiment, the access event message requests a user to identify the unknown person and associate an access level with the unknown person.

In another embodiment, the access database includes records of individuals known to a user including image data representative of the individuals and having no access level data associated therewith and step 614 may also include generating a set of candidate persons attempting access to the dwelling based visual similarities between the capture image data and image data representative of known individuals having no access level data associated therewith and generating the access event message including the set of candidate persons for display on the at least one device. In this embodiment, a response message may be received from the at least one device, the response message including data representing a respective one of the candidate persons and data identifying an access level associated with the respective one of the candidate persons the access database may be updated based on the response message.

In a further embodiment, step 614 may include generating an access event message including data identifying all access attempts during a predetermined time period and communicating the access event message including all access attempts to at least one device for display thereon. In this embodiment, the access event message including data identifying all access attempts includes data identifying at least one of (a) the person attempting to access the dwelling; (b) a time stamp identifying a time of attempted access; (c) a date stamp identifying a date of attempted access; (d) whether or not access was permitted based on access level information associated with the person; and (e) data identifying a manner in which the user may contact the person attempting access to the dwelling.

It should be understood that the elements shown and discussed above, may be implemented in various forms of hardware, software or combinations thereof. Preferably, these elements are implemented in a combination of hardware and software on one or more appropriately programmed general-purpose devices, which may include a processor, memory and input/output interfaces. The present description illustrates the principles of the present disclosure. It will thus be appreciated that those skilled in the art will be able to devise various arrangements that, although not explicitly described or shown herein, embody the principles of the disclosure and are included within its scope. All examples and conditional language recited herein are intended for informational purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated by those skilled in the art that the block diagrams presented herewith represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

1. An apparatus comprising
an image capturing device for capturing a captured image representing an individual;
a database including a plurality of user records, each of said plurality of user records including a user identifier, a user access level and a user image; and
a controller operative to receive said captured image from the image capturing device, comparing said captured image to said user image, determining a user identifier and user access level in response to said comparison, said controller further operative to control a locking mechanism to move from a first locked position to a second unlocked position in response to said user access level.

2. The apparatus of claim 1, further comprising
a communication interface that enables communication with at least one device on network.

3. The apparatus of claim 2, wherein
said controller further operative to generate an access event message including said user identifier.

4. The apparatus of claim 1, wherein
the access level data includes one of (a) full access; (b) permission-based access requiring permission of a user to grant access; (c) event based access requiring at least one event criteria to be satisfied to grant access; and (d) no access.

5. The apparatus of claim 1, wherein the controller is further operative to generate a new user record in response to the comparison of said captured image and said user image failing to determine said user identifier.

6. The apparatus of claim 5, wherein said controller is further operative to generate an event message requesting a a new user identifier in response to the comparison of said captured image and said user image failing to determine said user identifier.

7. The apparatus of claim 5, wherein
said database includes records of individuals known to a user including image data representative of the individuals and having no access level data associated therewith.

8. The apparatus of claim 7, wherein
the controller generates a set of candidate persons attempting access to the dwelling based visual similarities between the capture image data and image data representative of known individuals having no access level data associated therewith, wherein the access event message includes the set of candidate persons for display on the at least one device.

9. The apparatus of claim 8, further comprising a communication interface operative to receive said new user identifier.

10. The apparatus of claim 9, said controller further operative to generate an access event message including data identifying a plurality of access attempts during a time period and the communication interface operative to communicate the access event message including all access attempts to at least one device for display thereon.

11. The apparatus of claim 10, wherein
the access event message including data identifying all access attempts includes data identifying at least one of (a) the person attempting to access the dwelling; (b) a time stamp identifying a time of attempted access; (c) a date stamp identifying a date of attempted access; (d) whether or not access was permitted based on access level information associated with the person; and (e) data identifying a manner in which the user may contact the person attempting access to the dwelling.

12. A method of controlling access to a dwelling comprising
capturing, via an image capturing device, an image representing an individual attempting to access the dwelling;
receiving, at a controller, the captured image data from the image capturing device;
determining a level of access associated with the individual attempting access by comparing the captured image data with the image data representative of individuals stored in an access database, the access database including data identifying individuals known to a user and access level data associated with each individual known to the user, the data identifying individuals known to the user including image data representative of the individual; and
in response to determining that the access level indicates that access should be granted, controlling a locking mechanism to move from a first locked position to a second unlocked position enabling access to the dwelling.

13. The method of claim 12, further comprising
enabling communication between the controller and at least one other device on a network via a communication interface.

14. The method of claim 13, further comprising
generating an access event message including information identifying the person seeking access to the dwelling, information identifying a determined access level associated with the person seeking access to the dwelling and formatting information including formatting instructions used for displaying the access event message on the at least one device, and the communication interface communicates the access event message to the at least one device for display thereon.

15. The method of claim 12, wherein
the access level data includes one of (a) full access; (b) permission-based access requiring permission of a user to grant access; (c) event based access requiring at least one event criteria to be satisfied to grant access; and (d) no access.

16. The method of claim 13, further comprising
identifying the individual attempting to access the dwelling as an unknown person in response to determining that that image data associated with known individuals and stored in the access database does not match the captured image data.

17. The method of claim 16, further comprising
generating an access event message;
communicating the access event message to the at least one device for display thereon, the access event message requesting a user to identify the unknown person and associate an access level with the unknown person.

18. The method of claim 16, wherein
the access database includes records of individuals known to a user including image data representative of the individuals and having no access level data associated therewith.

19. The method of claim 18, further comprising
generating a set of candidate persons attempting access to the dwelling based visual similarities between the capture image data and image data representative of known individuals having no access level data associated therewith; and
generating the access event message including the set of candidate persons for display on the at least one device.

20. The method of claim 19, further comprising
receiving a response message from the at least one device, the response message including data representing a respective one of the candidate persons and data identifying an access level associated with the respective one of the candidate persons; and
updating the access database based on the response message.

21. The method of claim 13, further comprising
generating an access event message including data identifying all access attempts during a predetermined time period; and
communicating the access event message including all access attempts to at least one device for display thereon.

22. The method of claim 21, wherein
the access event message including data identifying all access attempts includes data identifying at least one of (a) the person attempting to access the dwelling; (b) a time stamp identifying a time of attempted access; (c) a date stamp identifying a date of attempted access; (d) whether or not access was permitted based on access level information associated with the person; and (e) data identifying a manner in which the user may contact the person attempting access to the dwelling.
